(19) United States
(12) Patent Application Publication
(10) Pub. No.: US 2002/0095852 A1
(43) Pub. Date: Jul. 25, 2002

(54) Harvesting boom with screen having replaceable sections

(76) Inventors: Thomas Bosteels, Salt Lake City, UT (US); Brad Marden, Ogden, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 09/974,334

(22) Filed: Oct. 10, 2001

Related U.S. Application Data
(60) Provisional application No. 60/239,215, filed on Oct. 10, 2000.

(51) Int. Cl. A01K 81/04

(52) U.S. Cl. 43/6.5

(57) ABSTRACT

The present invention provides a unique boom assembly for a brine shrimp harvesting device. More specifically, a novel boom assembly with replaceable modular panels is disclosed. The modular panels maybe water-permeable to trap brine shrimp eggs, while permitting water to pass out of the harvesting device. The modular panels may hang downward into a body of water from a boom, and may be weighted at the bottom end by an anchoring line. Each modular panel may be removably attached, through the use of suitable quick-release fastening mechanisms, to the boom, to the anchoring line, and to each adjacent modular panel. Thus, repair of the boom assembly may be rapidly carried out by replacing any damaged modular panel, without moving the boom assembly to any land-based facility. The boom assembly may therefore be used for continued harvesting while the damaged modular panel is repaired at a convenient location.

### RELATED APPLICATIONS

This application claims the benefit of U.S. Provisional Application No. 60/239,215 filed Oct. 10, 2000 and entitled HARVESTING BOOM SCREEN HAVING REPLACEABLE SECTIONS, which is incorporated herein by reference.

### BACKGROUND OF THE INVENTION

1. The Field of the Invention

The present invention relates to devices and methods used to gather brine shrimp eggs from the surface of a body of water. More specifically, the present invention relates to a novel harvesting boom assembly with a screen that is impermeable to brine shrimp eggs, yet water-permeable, having modular sections that are detachable for replacement or servicing.

2. The Relevant Technology

Brine shrimp eggs are a nutritious food source for fish and shrimp larvae. The eggs are harvested from the surface of a body of water with a high saline content. They can then be dried and stored for lengthy periods of time before use; consequently, they can be stockpiled to maintain a population of sea life during times when there is little natural food available.

Harvesting is normally accomplished by first concentrating floating brine shrimp eggs with one or more buoyant members or containment booms and then transferring the concentrated eggs to a harvesting boat. Some in the industry use booms designed to be drawn through the water to trap and concentrate the eggs. Mobile booms are usually towed, pushed, or otherwise propelled by one or more motorized boats. U.S. Pat. No. 5,457,908, for example, discloses a harvesting device that propels barriers through the water to gather eggs.

More common brine shrimp harvesting systems use a long, flexible barrier to encircle the floating brine shrimp eggs. The brine shrimp eggs are concentrated by gradually constricting the encircled eggs with the boom. U.S. Pat. No. 5,513,462 discloses one example of such a harvesting device.

Many boom assemblies have flexible skirt portions attached to the booms and arranged so as to hang from the booms to encapsulate more brine shrimp eggs. For such devices, water-permeable, or porous, skirts may beneficially be utilized. Water-permeable skirts produce less drag than water-impermeable skirts because water can simply flow through the mesh material, rather than being displaced by it. However, such water-permeable skirts can be problematic because they are necessarily delicate and thin. In order to have a mesh fine enough to retain eggs, yet allow water to pass through, a very fine grade mesh material must be used.

As a result, known water-permeable skirts are often damaged by branches, driftwood, pieces of sharp plastic, sharp metal structures, or other foreign objects captured by the boom assembly. Resulting holes in the skirt portions are often quite large; tears between one and five feet in length are not uncommon. Water may flow through such holes and escape from the harvesting device, carrying eggs with it.

Typical prior art boom assemblies have skirt portions that are permanently attached by sewing, an adhesive, or some other permanent form of assembly. Thus, removing the skirt portion for replacement or convenient repair is not feasible. Rather, when a hole is discovered in a permeable skirt, the boom assembly must typically be removed from the body of water for servicing. The hole may then be mended in some fashion.

Typically, the process of mending a hole in a water-permeable skirt is somewhat time-consuming, and must be performed in a controlled environment, i.e., away from the body of water. For example, if the hole is sewn shut, considerable machinery or man-hours may be required to provide enough stitches for effective repair. If adhesives are used to patch or otherwise close the hole, the skirt portion must first be cleaned and dried so that the adhesive will set properly. Such procedures are difficult to perform in an aqueous environment, such as on the surface of a body of water.

Consequently, the boom assembly, and possibly the entire harvesting device, must often be removed to a suitable land-based facility for repair. Even if repair may be effected on a harvesting boat on the surface of the water, valuable harvesting time is lost during the time-consuming mending process. Even worse, if mending is not possible, the boom assembly may need to be replaced, or a new water-permeable skirt portion may need to be made and attached to the boom. In either case, brine shrimp egg production has been curtailed for the sake of repair.

Furthermore, since the water-permeable skirt portions are typically connected to long booms, the holes that form tend to enlarge themselves until they are repaired. Without some form of boundary in the skirt portion, tears may propagate without limitation. The fluid drag acting against the skirt portion tends to pull fabric back from the hole, thereby enlarging the hole.

Previously known harvesting assemblies are also often somewhat difficult to manufacture because the parts used, such as the skirt portion, are specially and integrally manufactured. Parts of one harvesting device often may not be used with another harvesting device.

In addition, available water-permeable skirts typically are not easily adapted for harvesting under a variety of conditions. For example, if smaller eggs are to be captured, a finer skirt portion may be required. Similarly, if the water contains particles sized smaller than the eggs, a coarser skirt portion may be helpful. However, as with repair of the skirt portion, adaptation typically requires withdrawal of the entire harvesting device from the water, and extensive reworking of the existing components to outfit them for use under different conditions.

Thus, it would be an advancement in the art to provide a boom assembly with a water-permeable skirt, for a brine shrimp egg harvesting device, that could be quickly and easily repaired, without the need to specially fabricate replacements for each damaged permeable skirt section. It would be a further advancement in the art to provide a boom assembly that could be repaired without withdrawing the boom assembly from the site of harvesting, to a land-based repair facility.

Yet further, it would be an advancement in the art to provide a boom assembly capable of containing holes that form in the water-permeable skirt portion to ensure that they do not become significantly larger. Still further, it would be an advancement in the art to provide a boom assembly that could be easily assembled from standardized, interchangeable parts. Additionally, it would be an advancement in the art to provide a boom assembly that could be easily adapted for use in different conditions.

### BRIEF SUMMARY OF THE INVENTION

The apparatus of the present invention has been developed in response to the present state of the art, and in particular, in response to the problems and needs in the art that have not yet been fully solved by currently available boom assemblies for brine shrimp egg harvesting devices. Thus, it is an overall objective of the present invention to provide a boom assembly that remedies the problems of prior art harvesting devices.

To achieve the foregoing objective, and in accordance with the invention as embodied and broadly described herein in the preferred embodiment, a novel boom assembly for a brine shrimp egg harvesting device is provided. The boom assembly may have a boom designed to float on the surface of a body of water, a screen hanging from the boom within the water, and an anchoring line attached to the bottom of the screen to keep the screen in a generally downward-hanging orientation. The screen may have a coarse mesh designed to provide structural strength and support, and a fine mesh designed to capture brine shrimp eggs.

The fine mesh may be separated into one or more several separate modules, or modular panels, each of which is independently attachable to the boom and the anchoring line. The modular panels may be rectangular in shape, and may be positioned in abutting fashion so as to attach to each other. Suitable fastening mechanisms, such as zippers, clips, hooks, grommets, hook-and-loop systems, laces or ropes, snaps, clips, or the like may be used to attach the modular panels to the boom, the anchoring line, and each other. Preferably, the fastening mechanisms provide secure fastening, and yet are easy to attach and detach. The fastening mechanisms should have a long life in a salt water environment. Multiple types of fastening system may be used with each modular panel, if desired. The coarse mesh may have a modular design similar to that of the fine mesh.

The modular design of the modular panels provides significant benefits for the present invention. Since the modular panels are separate and easy to remove, each may be independently removed for repair, cleaning, or replacement. The modular panels may be easily removed and replaced without moving them to any land-based facility. A damaged modular panel need not be repaired before harvesting can continue. Rather, the damaged modular panel may be set aside and replaced with an undamaged panel so that harvesting may continue. The damaged panel may then be repaired while the boom assembly is used for further harvesting with the undamaged modular panel.

Furthermore, the boom, modular panels, and anchoring line may all be fabricated separately and easily assembled. Because the fastening mechanisms will not propagate a tear between two modular panels, a tear in one modular panel may not expand beyond the dimensions of the modular panel. Additionally, all of the modular panels of the boom assembly may be rapidly and easily replaced to adapt the boom assembly for use under different conditions.

These and other objects, features, and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and objects of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of one embodiment of a brine shrimp harvesting device according to the invention; and

FIG. 2 is a perspective view of one embodiment of a portion of a boom assembly with a skirt portion comprising removable modular panels of fine mesh.

### DETAILED DESCRIPTION OF THE PREFERRED EMBODIMENTS

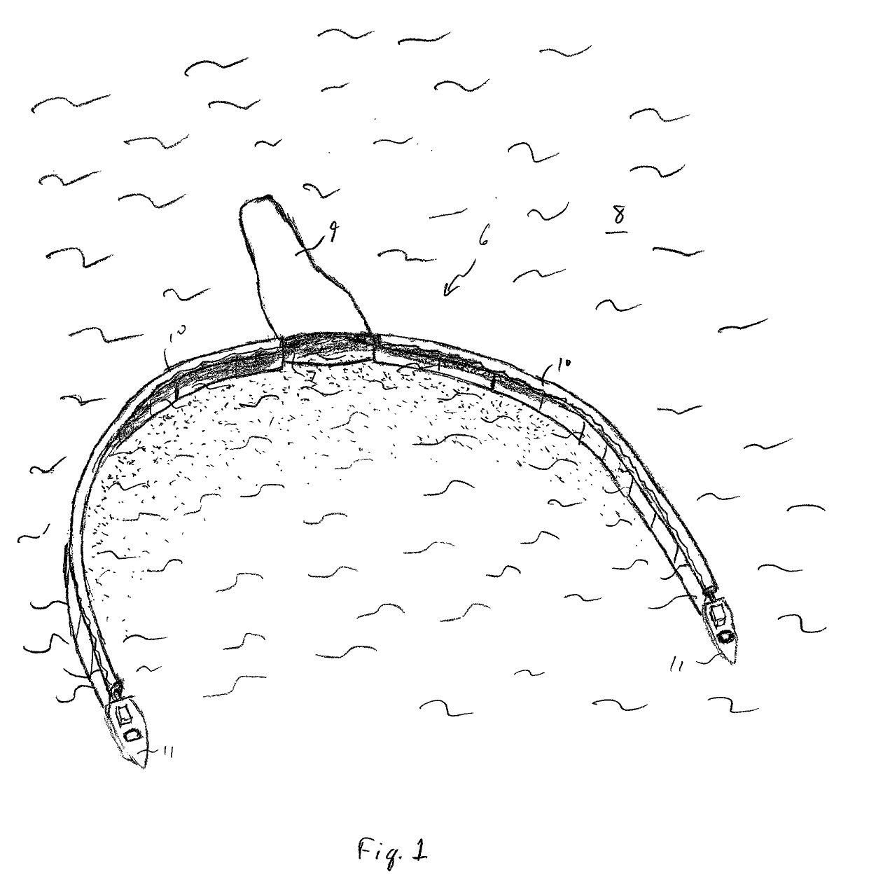

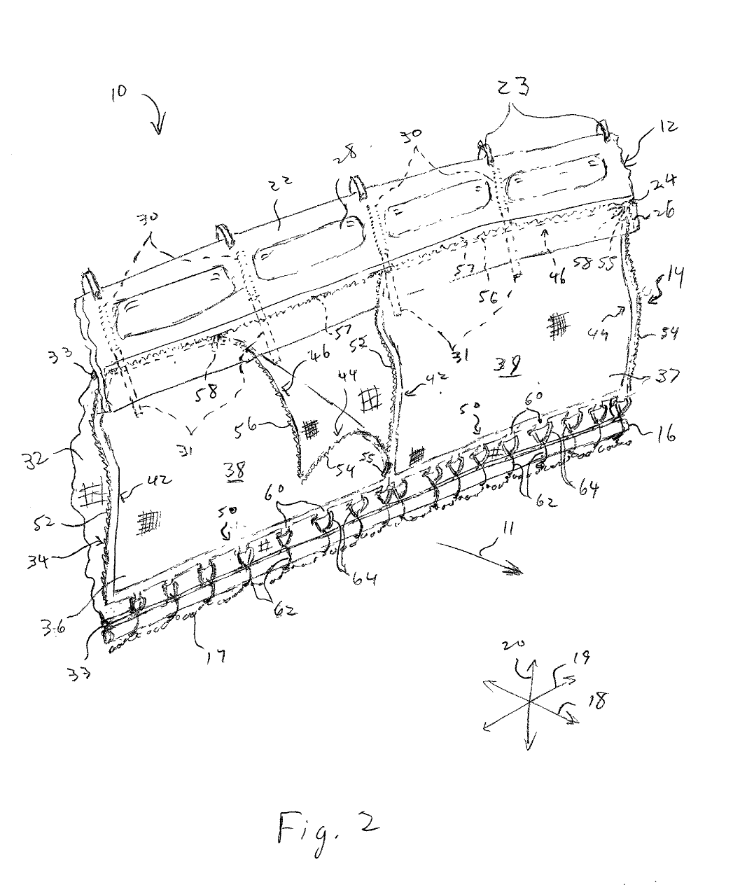

The presently preferred embodiments of the present invention will be best understood by reference to the drawing, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 and 2, is not intended to limit the scope of the invention, as claimed, but is merely representative of presently preferred embodiments of the invention.

A boom assembly for a brine shrimp harvesting device is designed to capture and channel brine shrimp eggs for collection. However, like a chain, the boom assembly is only as effective as its weakest member, because water will tend to flow across any obstruction to reach a passageway, i.e., a hole, to escape the advancing boom assembly. As the water flows rapidly toward and through the hole, brine shrimp eggs are carried out from the boom assembly, and thus may not be captured effectively.

The skirt portion hanging from the boom has consistently been the weakest part of the boom assembly. If the skirt is to be water-permeable, a fine mesh must be provided, so that the tiny brine shrimp eggs are not permitted to escape. The fine mesh is necessarily vulnerable to damage by larger objects in the water.

The present invention utilizes modular construction to obtain benefits not realized by previously known brine shrimp harvesting devices. More particularly, the conventional skirt portion is replaced by a plurality of modular panels, each of which may be easily replaced when needed.

Referring to FIG. 1, one embodiment of a harvesting device 6 according to the invention is shown. The harvesting device 6 may be designed to collect brine shrimp eggs from a body of water, designated 8. The harvesting device 6 may have a collector 9 into which the brine shrimp eggs 7 are to be gathered for conveyance from the body of water 8. Boom assemblies 10 may be connected to the collector 9 in such a manner that the brine shrimp eggs 7 are channeled by the boom assemblies 10 into the collector 9 from a sizable region of the body of water 8. Vessels 11, which may be motorized boats, may be used to propel the boom assemblies 10 along the body of water 8. Eggs gathered by the collector 9 may either be conveyed directly to shore within the collector 9, or may first be transferred to a collection boat (not shown).

Numerous other configurations may be used in place of the configuration shown in FIG. 1. For example, a single boom assembly 10 may extend in a loop from a vessel such as a boat. The vessel may simply draw one end of the boom assembly 10 to tighten the loop, thereby drawing brine shrimp eggs toward the vessel. The vessel need not move during collection, but may simply receive the brine shrimp eggs directly through the use of conveyer belts, suction devices, or the like. Thus, the boom assembly 10 of the invention is not limited to use with the harvesting device 6 of FIG. 1.

Referring to FIG. 2, one possible embodiment of a portion of the boom assembly 10 is depicted. The boom assembly 10 may be made as long as desired in order to capture larger numbers of eggs with fewer passes through the water.

The boom assembly 10 may have a boom 12 configured to float on the surface of the body of water. As mentioned previously, the boom 12 may be drawn through along the body of water 8 by one or more vessels such as the vessels 11 of FIG. 1. The boom 12 may move generally in a direction 13. A screen 14 may hang downward into the body of water from the boom 12. The screen 14 may be water-permeable, or water-impermeable, depending on the configuration of the harvesting device (not shown) to which the boom assembly 10 is attached.

The screen 14 may be attached at the lower end to an anchoring line 16 that exerts tension on the lower end of the screen 14 to keep the screen 14 upright. The anchoring line 16 may be a flexible member, such as a chain or rope, with a negative buoyancy, so that the weight of the anchoring line 16 exerts downward pressure against the bottom of the screen 14.

Alternatively, a weighted member 17, such as the chain 17 depicted in FIG. 2, may be attached to the anchoring line 16 along its length. For example, straps or the like may be used to intermittently tie links of the chain 17 to the anchoring line 16. If desired, the anchoring line 16 and/or the chain 17 may be drawn through the water in the same fashion as the boom 12, and may be positioned slightly ahead of the boom 10 in the water so as to shape the screen 14 into a scoop configuration, so that brine shrimp eggs are gathered toward the surface of the water.

For purposes of the following description, the boom assembly 10 has a longitudinal direction 18, a lateral direction 19, and a transverse direction 20. The direction 13 in which the boom 12 is propelled is generally parallel to the longitudinal direction 18.

The boom 12 may generally be constructed of any suitable material. However, a water-resistant, lightweight polymeric material, such as nylon, rubber, or a treated fabric, is preferred. The boom 12 may have a flotation portion 22 configured to add buoyancy to the boom 12, and also to act as a barrier against any flow of brine shrimp eggs over the boom 12. The floatation portion 22 may directly be gripped and propelled through the water by a boat. The floatation portion 22 may have a plurality of loops 23, arrayed as shown, to facilitate handling and control of the boom 12. An attachment portion 24 of the boom 12 may provide a suitable surface for attaching the screen 14.

A depending portion 26 may also be provided underneath the attachment portion 24, and may consist simply of a flap of the boom material. The depending portion 26 may be partially submerged while the boom assembly 10 is in operation. Buoyant chambers 28 of the flotation portion 22 may be configured as watertight pockets in the material of the flotation portion. The buoyant chambers 28 may contain foam, air, or some other similarly buoyant material. The buoyant chambers 28 need not be dimensioned or shaped as shown, but may, for example, be longer, depending on the geometry of the boom 12.

If desired, the boom 12 may also have one or more pockets 30 rearwardly disposed on the boom 12. The pockets 30 may open downward such that the pockets 30 can optionally receive stiffening rods 31. The stiffening rods 31 may be constructed of a stiff, lightweight material such as fiberglass. The stiffening rods 31 may be affixed within the pockets 30, tied to the screen 14, or otherwise fixed in position so that they are not dislodged from the pockets 30 during operation of the boom assembly 10.

The stiffening rods 31 may operate to stiffen the boom 12 against vertical bending. Thus, the boom 12 may remain relatively upright during harvesting. An upright orientation of the boom 12 may enhance the collection rate of brine shrimp eggs 7 by preventing the brine shrimp eggs 7 from being washed over the boom 12 during rapid motion of the boom 12 in the direction 13 or during choppy water conditions.

The screen 14 maybe of any type suitable for trapping brine shrimp eggs. Thus, the screen 14 may be water-impermeable, so that water is trapped within a harvesting device, together with brine shrimp eggs. Alternatively, the screen 14 may be water-permeable to permit water passage through the screen 14, while brine shrimp eggs are retained. In the embodiment of FIG. 2, the screen 14 is water-permeable. A water-permeable screen may enable the capture of a large volume of brine shrimp eggs with a comparatively low water content.

The screen 14 may have a coarse mesh 32 and a fine mesh 34. The fine mesh 34 may be constructed of a fine, woven material having openings on the order of 100 to 200 microns in size. Thus, brine shrimp eggs will not pass through the fine mesh 34, but water may pass through with a comparatively small flow restriction. Due to the delicate nature of the fine mesh 34, the coarse mesh 32 is preferably provided so as to support the fine mesh 34 against damage by turbulent water flows or solid material on or near the surface of the water. Preferably, the coarse mesh is made with much thicker or stronger fibers, and has much larger openings than the fine mesh 34. Thus, the coarse mesh 32 may be positioned behind the fine mesh 34, with respect to the direction 13 of motion of the boom assembly 10 through the water.

The coarse mesh 32 may be tied, sewed, fastened, or otherwise attached to the fine mesh 34. In the alternative, the coarse mesh 32 may simply be attached to or integrally formed with cords 33 that are, in turn, affixed along the length of the attachment portion 24 and to the anchoring line 16, so that the coarse mesh 32 hangs alongside the fine mesh 34, independently of the fine mesh 34. For example, one of the cords 33 may pass within loops (not visible in FIG. 2) sewn or otherwise attached to the attachment portion 24, and the other may be lashed to the anchoring line 16 through the use of a thin twine or cord.

The screen 14 maybe divided into a number of easily-removable modular sections, or modular panels. The boom assembly 10, only a portion of which is depicted in FIG. 2, may comprise several such modular panels. In FIG. 2, a first modular panel 36 and a second modular panel 37 are depicted by way of example. The first and second modular panels 36 and 37 may be rectangular as depicted, or have any other rounded or flat-sided configuration tending to conform to the shapes of the boom 12 and the anchoring line 16.

The modular panels 36, 37 may also be of any desired size. Preferably, the modular panels 36, 37 have a length ranging from about 3 feet to about 50 feet. More preferably, the modular panels have a length ranging from about 5 feet to about 20 feet. Yet more preferably, each of the modular panels 36, 37 may have a length ranging from about 5 feet to about 10 feet. If desired, each modular panel 36 may be made with a length equal to the length of the boom 12, such that each boom assembly 10 has only a single modular panel 36. Many of the benefits of the present invention may still be obtained without providing multiple modular panels 36 for each boom assembly 10.

The modular panels 36, 37 preferably extend into the water deep enough to capture brine shrimp eggs floating on the surface of the water and suspended a small distance beneath the surface of the water. Thus, the modular panels 36, 37 preferably have a depth ranging from about 4 inches to about 100 inches. More preferably, the modular panels 36, 37 have a depth ranging from about 24 inches to about 72 inches. A depth of about 24-48 inches may be optimal for the modular panels 36, 37. The optimal depth for the panels 36, 37 may, however, vary according to the type of brine shrimp eggs to be harvested, the saline content of the water, the operating speed of the harvesting device, and other factors.

The first modular panel 36, for example, may be substantially rectangular in shape, and may be configured to be attached directly and removably to the attachment portion 24 of the boom 12 and to the anchoring line 16. The first modular panel 36 may also be removably attached to adjacent panels, such as the second modular panel 37. Attachment may occur by any method providing comparatively rapid attachment and removal. The first and second modular panels 36, 37 may have first and second water-permeable portions 38, 39, centrally located in each panel, where eggs may be trapped and water may be permitted to pass through.

“Comparatively rapid attachment” and “comparatively rapid removal” describe attachment and removal procedures that may be performed without removing the boom assembly 10 to any land-based facility. Thus, any attachment or removal process that is “comparatively rapid” will not require excessive amounts of time. For example, it is contemplated that each of the panels 36, 37 may be removed in five to ten minutes or less. Similarly, it is envisioned that the entire repair process, including the time required to pull the boom assembly 10 onto a harvesting boat and replace it within the water, will require less then one hour, preferably less than thirty minutes, and more preferably less than twenty minutes.

Similarly, if any tooling is required to carry out attachment or removal, the tooling may beneficially be compact and usable in an aqueous, mobile environment. Attachment in “quick-release fashion” refers to an attachment process that may be rapidly carried out in relation to a boom assembly 10 remote from the harvesting site. Hence, a “a quick-release fastening mechanism” is a fastening mechanism capable of carrying out comparatively rapid fastening and unfastening.

Each of the first and second modular panels 36, 37 may have a number of edges that can be independently fastened to the attachment portion 24, the anchoring line 16, or other modular panels. For example, the modular panel 36, 37 may each have a left edge 42, a right edge 44, a top edge 46 abutting the attachment portion 24, and a bottom edge 50 adjacent to the anchoring line 16. The left and right edges 42, 44 may be referred to as “lateral edges.” The right edge 44 of the first modular panel 36 may abut the left edge 42 of the second modular panel 37. Each of the edges 42, 44, 46, 50 may have its own fastening mechanism. In the alternative, one fastening mechanism may be used to provide attachment of more than one, or even all, of the edges 42, 44, 46, 50.

A “fastening mechanism” is any device or assembly that connects one part to another. A fastening mechanism may include one or more attachment features affixed to or integrally formed with the parts to be attached. Additionally, a fastening mechanism may or may not include a “fastener” separate from the attachment features. A “fastener” may be defined as any solid device configured to connect one part to another.

Fastening mechanisms that can be used with the present invention include bolts, nuts, screws, snaps, clips, ropes, laces, chains, zippers, hook-and-loop systems, hooks, grommets, and the like. Some fastening mechanisms, such as hook-and-loop systems, have only attachment features permanently affixed to the parts to be attached. No fasteners are then needed. Other attachment mechanisms have holes, loops, or other attachment features designed to be attached together through the use of fasteners such as nuts, bolts, laces, and the like. In the case of a zipper, two separate attachment features, i.e., two separate zipper halves, may be attached to each other through the use of a fastener, i.e., a slider that receives the zipper halves and induces them to mesh with each other.

For example, the left edge 42 of each modular panel 36, 37 may have a left attachment feature 52, and the right edge 44 may have a right attachment feature 54. The left and right attachment features 52.54 may be referred to as “lateral attachment features.” The left and right attachment features 52,54 may optionally take the form of zipper halves. Thus, the right attachment feature 54 of the first modular panel 36 may, for example, engage the left attachment feature 52 of the second modular panel 37. A slider 55 may be used to selectively mesh the right and left attachment features 54, 52 to form a complete zipper.

Similarly, the top edge 46 may have a top attachment feature 56 configured to engage an attachment feature 57 affixed to the attachment portion 24. The top attachment feature 56 and the attachment feature 57 may also be configured as zipper halves selectively meshed together by a slider 58. If desired, the left attachment feature 52, the right attachment feature 54, and the top attachment feature 56 may form one continuous zipper half so that the modular panels 36, 37 can be attached to the attachment portion 24 and to each other, and any other modular panels outside the view of FIG. 2, through the motion of a single slider (not shown).

The bottom edge 50 may have a bottom attachment feature 60 configured to provide attachment of the first modular panel 36 to the anchoring line 16. If the anchoring line 16 takes the form of a chain or rope, use of a zipper may be difficult because of the need to securely attach a zipper half to the anchoring line 16. Thus, an alternative type of fastening mechanism, such as an array of clips, may be utilized.

Accordingly, the bottom attachment feature 60 may take the form of a plurality of loops distributed along the bottom edge 50 and extending from the bottom edge 50 toward the anchoring line 16. The loops 60 may simply be formed in the fabric of the bottom edge 50. A plurality of rings 62 may also be arrayed along the anchoring line 16 in alignment with the loops 60. The rings 62 maybe constructed of a corrosion resistant metal such as stainless steel, aluminum, plastic, rubber, or the like. In the alternative, loops made of rope, fabric, twine, cable, or the like could be used in place of the rings 62.

The rings 62 of the anchoring line 16 maybe attached to the loops 60 of the bottom edge 50 in quick-release fashion by a series of clips 64. Each of the clips 64 may have a spring-loaded closure member or the like, so that a user can manually move each of the clips 64 into an open position to remove the clips 64 from the rings 62 and/or the loops 60. If desired, the clips 64 may be permanently attached to, or even integrally formed with, the rings 62 such the clips 64 remain coupled to the anchoring line 16 when one of the modular panels 36, 37 is removed.

The left attachment features 52, right attachment features 54, top attachment features 56, and bottom attachment features 60 may all take any form consistent with the purpose of the present invention, i.e., rapid attachment and removal of the panels 36, 37 from the boom assembly 10. Thus, the fastening mechanisms used to attach the edges 42, 44, 46, 50 of the modular panels 36, 37 need not be zippers, but may comprise bolts, nuts, screws, snaps, clips, ropes, zippers, hook-and-loop systems, hooks, grommets, or any other quick-release attachment features and/or fasteners.

If desired, the coarse mesh 32 may also be made modular, similar to the fine mesh 34. For example, the coarse mesh 32 may also have modular panels, similar to the first and second modular panels 36, 37 of the fine mesh 34. Modular panels of the coarse mesh 32 may have attachment features similar to the attachment features 52, 54, 56, 58 so that parts of the coarse mesh 32 can be rapidly assembled and replaced.

The fine mesh 34 or the coarse mesh 32 may also optionally be configured with a flexible frame (not shown) into which the modular portions may be attached. For example, the boom 12 maybe covered with a fabric or other flexible material that extends downward through the water to cover the anchoring line 16. Large openings may be formed in the material of the frame, with attachment features at the periphery of each opening. The first and second modular panels 36, 37 may then be attached within separate openings, or windows, of the frame, instead of attaching the first and second modular panels 36, 37 directly to each other, the boom 12, and the anchoring line 16. Such a flexible frame may provide additional support for the first and second modular panels 36, 37 and their associated attachment mechanisms 52, 54, 56, 58.

When one of the modular sections is damaged, for example, the first modular panel 36, repair of the boom assembly 10 may be rapidly carried out with the present invention. The harvesting device to which the boom assembly 10 is attached may then continue operating with a minimum of delay.

Repair may be effected by, first, removing the boom assembly 10, or the damaged portion thereof, from the water onto an available boat (not shown), such as a boat used to tow the boom assembly 10. Alternatively, the boom assembly 10 may be replaced while resting in the water. In any case, the boom assembly 10 need not be transported to a land-based repair facility, but may simply be repaired on board the boat. The boom assembly 10 may be pulled on board the boat in a matter of minutes by hand or through the use of suitable machinery on the boat.

The first modular panel 36 may then be removed from the boom assembly 10 by detaching the attachment features 52, 54, 56, 58 from other parts of the boom assembly 10. Because fastening mechanisms incorporating the attachment features 52, 54, 56, 58 are of a quick connect/quick-disconnect type, removal may be rapidly achieved on site. After the first modular panel 36 has been removed, it may be replaced with another, similar panel. The boom assembly 10 may then be returned to the water so that brine shrimp egg gathering may commence.

Replacement of the first modular panel 36 maybe carried out in a matter of minutes, for example, five to ten minutes or less. The entire repair process, including time required to remove the boom assembly 10 from the water and replace it in the water again, may similarly be rapidly accomplished. For example, the repair process may require between ten and thirty minutes or less, and preferably less than twenty minutes.

The boom assembly 10 may thus continue to operate with a minimum of downtime. The first modular panel 36 may then be repaired, remotely from the boom assembly 10, for example, in a maintenance building or other suitable repair facility.

Furthermore, when the boom assembly 10 is first fabricated, the fine mesh 34 may be created in smaller, more manageable sections (panels) and subsequently assembled. The fine mesh 34 need not be manufactured unitarily with the boom 12 or permanently attached through any time-consuming process. Rather, the first and second panels 36, 37 may be positioned and attached within the boom assembly 10 by hand, with little fixturing or tooling.

The geometry of the first and second modular panels 36, 37 may also serve to prevent propagation of tears through the fine mesh 34. For example, a tear in the first modular panel 36 may not be able to traverse the right edge 44 of the first modular panel 36 because the right attachment feature 54 of the first modular panel 36 is unable to transmit the tear through the left attachment feature 55 of the second modular panel 37. As a result, the tear is effectively contained within the first modular panel 36.

Additionally, the boom assembly 10 may easily be adapted to use under varying conditions. For example, if smaller brine shrimp eggs are to be collected, the modular panels 36, 37 may be rapidly removed and replaced with similar panels having a finer mesh. Alternatively, if a good deal of small, extraneous material is present in the water, the modular panels 36, 37 may be exchanged for panels having larger openings, so as to permit pass-through of the extraneous material.

In addition, modular panels 36, 37 having different water permeability can be used on a single boom assembly. For instance, water impermeable modular panels can be located adjacent to the vessels 1 1. Water permeable modular panels may be disposed rearward of the water impermeable panels, where the brine shrimp eggs 7 are concentrated.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A boom assembly for a brine shrimp egg harvesting device, the boom assembly comprising:
a boom with a density selected to permit floatation in water with a high saline content; and
a first modular panel suspended from the boom, the first modular panel having a water-permeable portion that captures brine shrimp eggs and a top edge attached to the boom in quick-release fashion.

2. The boom assembly of claim 1, further comprising a second modular panel suspended from the boom, the second modular panel having a water-permable portion that captures brine shrimp eggs and a top edge attached to the boom in quick-release fashion, wherein a lateral edge of the first modular panel is attached to a lateral edge of the second modular panel in quick-release fashion.

3. The boom assembly of claim 2, further comprising third and fourth modular panels suspended from the boom, each of the third and fourth modular panels having a water permeable portion that captures brine shrimp eggs and a top edge attached to the boom in quick-release fashion alongside the first and second modular panels.

4. The boom assembly of claim 1, further comprising a reinforcement panel suspended from the boom alongside the first modular panel to support the first modular panel against mechanical rupture.

5. The boom assembly of claim 4, wherein the reinforcement panel is substantially permanently affixed to the boom, and wherein the water-permeable portion of the reinforcement panel is substantially free of attachment to the water-permeable portion of the first modular panel.

6. The boom assembly of claim 1, wherein the first modular panel has a length ranging from about three feet to about 50 feet.

7. The boom assembly of claim 1, wherein the top edge of the first modular panel is attached to the boom by a quick-release fastening mechanism comprising a fastener selected from the group consisting of rigid mechanical fasteners and flexible fasteners.

8. The boom assembly of claim 7, wherein the quick-release fastening mechanism comprises a zipper, the zipper comprising a zipper half affixed to the boom and a corresponding zipper half affixed to the top edge of the modular panel to mesh with the zipper half affixed to the boom.

9. The boom assembly of claim 1, further comprising an anchoring line disposed underneath the first modular panel, the first modular panel further comprising a bottom edge attached to the anchoring line in quick-release fashion.

10. The boom assembly of claim 9, wherein the bottom edge of the first modular panel is attached to the anchoring line by a plurality of clips.

11. A brine shrimp egg harvesting device that collects brine shrimp eggs from a body of water, the brine shrimp egg harvesting device comprising:
a boom with a density selected to permit floatation in water with a high saline content;
a screen suspended from the boom, the screen having at least a first modular panel removable from the boom and from a remainder of the screen portion via at least one quick-release fastening mechanism, the first modular panel having a water-permeable portion that captures brine shrimp eggs; and
a vessel that propels the boom along the body of water to gather brine shrimp eggs with the screen.

12. The brine shrimp egg harvesting device of claim 11, wherein the screen comprises a plurality of modular panels, each of which comprises at least one lateral edge attached to a lateral edge of an adjacent modular panel by a quick-release fastening mechanism.

13. The brine shrimp egg harvesting device of claim 11, wherein the quick-release fastening mechanism comprises a zipper, the zipper comprising a zipper half affixed to the boom and a corresponding zipper half affixed to the top edge of the modular panel to mesh with the zipper half affixed to the boom.

14. The brine shrimp egg harvesting device of claim 11, further comprising an anchoring line disposed underneath the first modular panel, the first modular panel further comprising a bottom edge attached to the anchoring line in quick-release fashion.

15. The brine shrimp egg harvesting device of claim 14, further comprising a reinforcement panel suspended from the boom alongside the first modular panel to support the first modular panel against mechanical rupture, wherein the reinforcement panel comprises a bottom edge attached to the anchoring line.

16. A modular panel for a brine shrimp egg harvesting device having a boom with a buoyant configuration, the modular panel comprising:
a water-permeable portion suspended from the boom to capture brine shrimp eggs; and
a top edge affixed to the water-permeable portion, the top edge comprising an attachment feature that provides quick-release attachment of the top edge to the boom via a corresponding attachment feature of the boom.

17. The modular panel of claim 16, further comprising a bottom edge affixed to the water-permeable portion, the bottom edge comprising an attachment feature that provides quick-release attachment of the bottom edge to an anchoring line via a corresponding attachment feature of the anchoring line.

18. The modular panel of claim 17, further comprising a lateral edge affixed to the water-permeable portion, the lateral edge comprising an attachment feature that provides quick-release attachment of the lateral edge to a second modular panel via a corresponding attachment feature of a lateral edge of the second modular panel.

19. The modular panel of claim 16, wherein the water-permeable portion comprises a mesh size ranging from about 100 microns to about 200 microns.

20. The modular panel of claim 16, wherein the water-permeable portion has a length ranging from about three feet to 50 feet.

21. A method for repairing damage to a screen of a brine shrimp egg harvesting device, the method comprising:
detaching a first top attachment feature affixed to a damaged modular panel of the screen from a boom supporting the screen at a first location;
removing the damaged modular panel from the first location;
positioning a comparatively undamaged modular panel of the screen at the first location; and
attaching a second top attachment feature affixed to the undamaged modular panel to the boom at the first location.

22. The method of claim 21, wherein detaching the first top attachment feature comprises unzipping a zipper, and wherein attaching the second top attachment feature comprises zipping a zipper.

23. The method of claim 21, further comprising detaching a left attachment feature and a right attachment feature affixed to the damaged modular panel from the screen.

24. The method of claim 21, further comprising detaching a bottom attachment feature affixed to the damaged modular panel from an anchoring line disposed underneath the first modular panel.

25. The method of claim 24, wherein detaching the bottom attachment feature comprises unclipping a clip.

26. A method for manufacturing a boom assembly for a brine shrimp harvesting device, the method comprising:
providing a boom with a boom attachment feature;
providing a first modular panel with a water-permeable portion that captures brine shrimp eggs and a top edge with a top attachment feature; and
attaching the top attachment feature to the boom attachment feature in quick-release fashion to removably attach the top edge of the first modular panel to the boom.

27. The method of claim 26, wherein each of the top and bottom attachment features comprises a zipper half, and wherein attaching the top attachment feature to the boom attachment feature comprises zipping the top and bottom attachment features together.

28. The method of claim 26, wherein the first modular panel further comprises a right lateral edge with a right attachment feature, the method further comprising:
providing a second modular panel with a water-permeable portion that captures brine shrimp eggs and a left lateral edge with a left attachment feature; and
attaching the right attachment feature to the left attachment feature in quick-release fashion to removably attach the second modular panel to the first modular panel.

29. The method of claim 26, wherein the first modular panel further comprises a bottom edge with a bottom attachment feature, the method further comprising:
providing an anchoring line;
disposing the anchoring line alongside the bottom edge; and
attaching the bottom attachment feature to the anchoring line in quick-release fashion to removably attach the bottom edge of the first modular panel to the anchoring line.

30. The method of claim 26, further comprising:
providing a reinforcement panel having a top edge;
disposing the top edge of the reinforcement panel proximate the top edge of the first modular panel; and
attaching the top edge of the reinforcement panel to the boom.
